(19) United States
(12) Patent Application Publication
(10) Pub. No.: US 2017/0163948 A1
(43) Pub. Date: Jun. 8, 2017

(54) PROJECTION APPARATUS AND CONTROL METHOD THEREOF, AND PROJECTION SYSTEM

(71) Applicant: CANON KABUSHIKI KAISHA, Tokyo (JP)

(72) Inventors: Keisuke Morisawa, Kawasaki-shi (JP); Miyako Takahashi, Kawasaki-shi (JP); Takeshi Ikeda, Ebina-shi (JP)

(21) Appl. No.: 15/361,914

(22) Filed: Nov. 28, 2016

(30) Foreign Application Priority Data
Dec. 3, 2015 (JP) 2015-236925

(51) Int. Cl. H04N 9/31; G06T 5/00; G09G 5/00; G06T 11/60

(52) U.S. Cl. CPC H04N 9/3179; G06T 11/60; G06T 5/00; G09G 5/003; G06T 2207/20021

(57) ABSTRACT

A projection apparatus constituting a projection system displaying a single image on a projection surface by overlapping and splicing together parts of a plurality of images projected by a plurality of projection apparatuses, the projection apparatus including: a light source; a light valve that modulates light based on image data; a projecting unit configured to project the light modulated by the light valve; a determining unit configured to determine an emission amount of the light source based on the image data; an acquiring unit configured to acquire information on an emission amount of a light source of another projection apparatus constituting the projection system; and a correcting unit configured to correct the image data based on the emission amount of the light source of the own projection apparatus and the emission amount of the light source of the other projection apparatus.

### BACKGROUND OF THE INVENTION

Field of the Invention

The present invention relates to a projection apparatus and a control method thereof, and to a projection system.

Description of the Related Art

Mechanisms for controlling an emission amount of a light source in accordance with image data in order to improve a dynamic range or a sense of contrast are being built into projectors. This is a technique for increasing a dynamic range of a moving image by reducing the emission amount of the light source for dark scenes and increasing the emission amount of the light source for bright scenes for the purpose of improving display quality. In recent years, such projectors use light sources other than conventionally-used lamps. For example, a light emitting diode (LED), a semiconductor laser, or an organic electroluminescence (organic EL or OEL) is used as a light source. These light sources enable an emission amount to be controlled and are referred to as solid-state light sources.

Meanwhile, there is a technique known as multi-projection in which projection images are spliced together on a projection surface in order to project a large-screen image. In multi-projection, a plurality of projectors are lined up and parts of projection images are overlapped with each other. A process (an edge blending process) is performed in which gradation of an overlapping region is lowered so that brightness levels of the overlapping region and a non-overlapping region become the same for the purpose of making slight positional deviations in the projection images less conspicuous. With methods involving overlapping parts of projection images as described above, a difference in black brightness is created between an overlapping region and a non-overlapping region. This is attributable to a phenomenon referred to as black floating in which even a black image has slight brightness since light cannot be sufficiently blocked even when black is projected by a projection apparatus. Since black floating is created independently of gradation, an edge blending process is ineffective against black floating. In an overlapping region, since black floating corresponding to the number of projection apparatuses which are projecting images to the overlapping region is added, black floating of the overlapping region exceeds that of a non-overlapping region. As a result, a difference is created between amounts of black floating of the overlapping region and the non-overlapping region.

As means for correcting such black floating of an overlapping region, there are methods of bringing amounts of black floating of an overlapping region and a non-overlapping region close to each other by adding an offset to the black floating of the non-overlapping region. For example, Japanese Patent Application Laid-open No. 2014-137386 makes black floating uniform over an entire image by sharing a black floating distribution unique to a projection apparatus that performs overlapping between projection apparatuses participating in multi-projection, calculating an amount of black floating of an overlapping region, and calculating an offset value of a non-overlapping region.

### SUMMARY OF THE INVENTION

However, the technique described above does not assume that an emission amount of a light source of a projector dynamically changes in accordance with an image. Since an amount of black floating is a unique distribution determined in advance by each projection apparatus, the technique described above cannot cope with a case where an amount of black floating of a projection apparatus dynamically changes in accordance with a projection image and a difference in amounts of black floating is created between an overlapping region and a non-overlapping region.

An object of the present invention is to suppress black floating in an overlapping region when dynamically variably controlling brightness of a light source in accordance with image data and improve display quality in a projection apparatus which performs multi-projection.

A first aspect of the present invention is a projection apparatus constituting a projection system displaying a single image on a projection surface by overlapping and splicing together, on the projection surface, parts of a plurality of images projected by a plurality of projection apparatuses, the projection apparatus including:

a light source;

a light valve that modulates light from the light source, based on image data;

projecting unit for projecting the light modulated by the light valve;

determining unit for determining an emission amount of the light source, based on the image data;

acquiring unit for acquiring information on an emission amount of a light source of another projection apparatus constituting the projection system; and

correcting unit for correcting the image data, based on the emission amount of the light source of the own projection apparatus and the emission amount of the light source of the other projection apparatus.

A second aspect of the present invention is a control method for a projection apparatus constituting a projection system displaying a single image on a projection surface by overlapping and splicing together, on the projection surface, parts of a plurality of images projected by a plurality of projection apparatuses,

the projection apparatus including:

a light source;

a light valve that modulates light from the light source, based on image data; and

projecting unit for projecting light modulated by the light valve,

the control method including:

determining an emission amount of the light source, based on the image data;

acquiring information on the emission amount of a light source of another projection apparatus constituting the projection system; and

correcting the image data based on an emission amount of the light source of the own projection apparatus and the emission amount of the light source of the other projection apparatus.

According to the present invention, black floating in an overlapping region can be suppressed and display quality can be improved when dynamically variably controlling brightness of a light source in accordance with image data in a projection apparatus which performs multi-projection.

Further features of the present invention will become apparent from the following description of exemplary embodiments with reference to the attached drawings.

### BRIEF DESCRIPTION OF THE DRAWINGS

FIG. 1 is a diagram showing an overall configuration of a first embodiment;

FIG. 2 is a block diagram showing a configuration of a projector according to the first embodiment;

FIG. 3 is a flow chart of a black correcting process according to the first embodiment;

FIG. 4 is a lookup table of emission amount and average gradation value;

FIG. 5 is a diagram showing an example of light source brightness according to the first embodiment;

FIG. 6 is a diagram showing an example of correction of black floating according to the first embodiment;

FIG. 7 is a diagram showing an example of an offset value according to the first embodiment;

FIG. 8 is a diagram showing an overall configuration of a second embodiment;

FIG. 9 is a block diagram showing a configuration of a projector according to the second embodiment;

FIG. 10 is a flow chart of a black correcting process according to the second embodiment;

FIG. 11 is a diagram showing an example of light source brightness according to the second embodiment;

FIG. 12 is a diagram showing an example of an offset value according to the second embodiment;

FIG. 13 is a block diagram showing a configuration of a projector according to a third embodiment; and

FIG. 14 is a flow chart of a black correcting process according to the third embodiment.

### DESCRIPTION OF THE EMBODIMENTS

### First Embodiment

A first embodiment of the present invention will be described below.

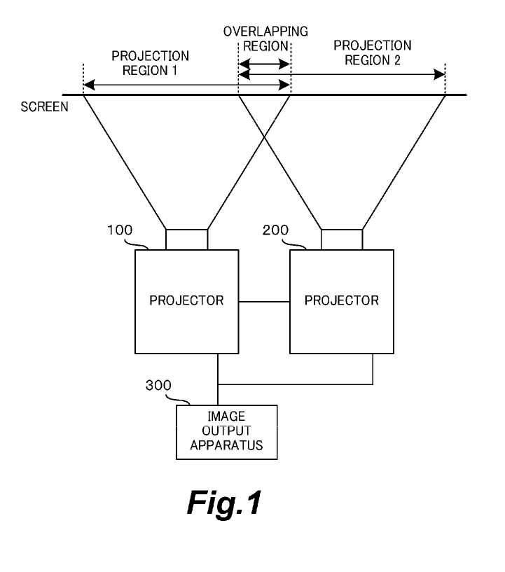

FIG. 1 is a diagram showing an outline of an arrangement of a system (a multi-projection system) which realizes multi-projection using projection apparatuses (projectors) according to the first embodiment of the present invention. The multi-projection system according to the first embodiment of the present invention will be described as an example in which, as shown in FIG. 1, two projectors 100 and 200 are used in a lateral direction.

An image output apparatus 300 is connected to the projectors 100 and 200 by an image cable and transmits image data. In addition, the projectors 100 and 200 communicate via a LAN cable.

The projectors 100 and 200 receive image data (an image signal) transmitted from the image output apparatus 300 and respectively project an image based on the image data. By overlapping and splicing together, on the projection surface, parts (portions in a vicinity of a boundary) of two images projected by the two projectors 100 and 200, a single large-screen image is projected to and displayed on the projection surface.

A projection region 1 is a projection region of an image projected by the projector 100 and a projection region 2 is a projection region of an image projected by the projector 200. An overlapping region is region where the projection regions 1 and 2 overlap each other. Regions other than the overlapping region in the projection regions 1 and 2 are referred to as non-overlapping regions.

Moreover, the image output apparatus 300 may be any apparatus such as a personal computer, a camera, a game device, and a smartphone as long as the apparatus is capable of outputting image data.

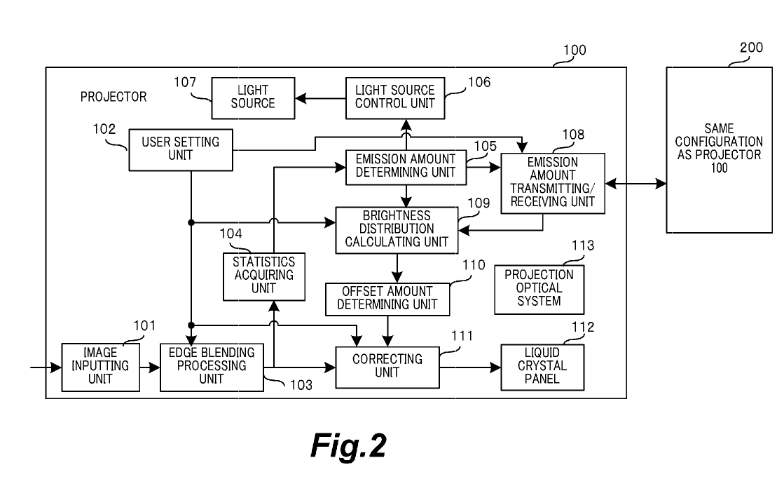

FIG. 2 is a block diagram showing a schematic configuration of the projector 100 according to the first embodiment.

A configuration of the projector 100 will now be described.

The projector 100 according to the first embodiment includes an image inputting unit 101, a user setting unit 102, an edge blending processing unit 103, a statistics acquiring unit 104, an emission amount determining unit 105, a light source control unit 106, a light source 107, an emission amount transmitting/receiving unit 108, and a brightness distribution calculating unit 109. The projector 100 further includes an offset amount determining unit 110, a correcting unit 111, a liquid crystal panel 112, and a projection optical system 113.

The image inputting unit 101 receives image data from an external apparatus. For example, the image inputting unit 101 includes a composite terminal, an S image terminal, a D terminal, a component terminal, an analog RGB terminal, a DVI-I terminal, a DVI-D terminal, a DisplayPort terminal, an HDMI (registered trademark) terminal, or the like. In addition, when the image inputting unit 101 receives analog image data, the image inputting unit 101 converts the received analog image data into digital image data. Furthermore, the image inputting unit 101 transmits received image data to the edge blending processing unit 103.

The user setting unit 102 accepts and manages an operation of a main body button of the projector 100 performed by a user for inputting setting information of the projector. Setting information of the projector includes a position, a size, a gamma curve, the number of overlapping projectors, and identification information of other overlapping projectors of an overlapping region in an edge blending process.

Moreover, a setting method involving setting by an operation of a remote controller, setting by network communication from a remote location, or the like can be adopted instead of an operation of a main body button.

The edge blending processing unit 103 acquires setting information such as a position, a size, and a gamma curve of an overlapping region in an edge blending process in which parts of adjacent projection images are overlapped with each other from the user setting unit 102. In addition, the edge blending processing unit 103 performs gamma adjustment with respect to an overlapping region of image data input from the image inputting unit 101.

The statistics acquiring unit 104 acquires statistics (a characteristic amount) of image data processed by the edge blending processing unit 103. The statistics acquiring unit 104 acquires an average gradation value of all pixels of the image data as statistics. The statistics acquiring unit 104 outputs calculated statistics to the emission amount determining unit 105.

Moreover, while an example in which an average gradation value is acquired as statistics is presented in the first embodiment, statistics are not limited thereto and, for example, a modal gradation value or other statistics representing brightness of an image may be used.

The emission amount determining unit 105 determines an emission amount of the light source 107 based on image data. In the first embodiment, the emission amount determining unit 105 determines an emission amount (a light source brightness value) of the light source 107 of the projector based on the average gradation value of the image data acquired by the statistics acquiring unit 104 and on a lookup table. The emission amount determining unit 105 outputs the determined emission amount to the light source control unit 106, the emission amount transmitting/receiving unit 108, and the brightness distribution calculating unit 109.

Moreover, while the emission amount determining unit 105 determines an emission amount using a lookup table in the first embodiment, an emission amount may be determined using a calculation formula.

The light source control unit 106 controls the light source 107 and causes light to be emitted based on an emission amount received from the emission amount determining unit 105.

The light source 107 is a solid-state light source (an LED) of which an emission amount can be controlled. An image is projected onto a screen using light from the light source 107. Moreover, while an LED is used as the light source 107 in the first embodiment, a semiconductor laser, an organic EL, and other light sources of which an emission amount can be controlled may be used instead.

The emission amount transmitting/receiving unit 108 acquires information on an emission amount of a light source of another projection apparatus constituting the projection system. In the first embodiment, the emission amount transmitting/receiving unit 108 transmits information on the emission amount of the projector 100 determined by the emission amount determining unit 105 to the projector 200 which is connected by a communication cable. In addition, the emission amount transmitting/receiving unit 108 receives information on an emission amount determined by the projector 200 in a similar manner to the projector 100.

As information necessary for communication setting such as projector identification information when connecting to an Ethernet (registered trademark) address of a projector that is a communication destination or when connecting to a plurality of projectors, the emission amount determining unit 105 uses information set by the user with the user setting unit 102.

Moreover, while the Ethernet is used as a communication system in the first embodiment, other communication systems such as a wireless LAN or USB may be used as long as transmission and/or reception of an emission amount is completed within one frame period (16 milliseconds in the case of a frame rate of 60 fps).

The brightness distribution calculating unit 109 calculates a brightness distribution in a projection region of the own projection apparatus based on the emission amount of the light source of the own projection apparatus and the emission amount of the light source of the other projection apparatus. In the first embodiment, the brightness distribution calculating unit 109 calculates a brightness distribution in a projection region by the projector 100 including an overlapping region created by edge blending.

Moreover, black floating occurs due to insufficient light shielding by the liquid crystal panel 112. The larger the emission amount of the light source 107, the higher the degree of black floating (the larger an amount of black floating). The brightness distribution in the projection region is based on the emission amount of the light source 107. Therefore, a distribution of the amount of black floating in the projection region is based on the brightness distribution in the projection region. Accordingly, while the first embodiment considers brightness and black floating in a projection region using an unmodified value of an emission amount for the sake of simplicity, correspondence relationships among an emission amount, brightness, and black floating may be defined by a lookup table or a calculation formula.

The brightness distribution calculating unit 109 acquires information on a position and a size of the overlapping region from the user setting unit 102, and uses the emission amount of the light source 107 of the projector 100 calculated by the emission amount determining unit 105 as brightness of a non-overlapping region.

In addition, the brightness distribution calculating unit 109 calculates an emission amount of the overlapping region based on the emission amount calculated by the emission amount determining unit 105 and the emission amount of the light source of the projector 200 acquired by the emission amount transmitting/receiving unit 108. Details will be provided later.

As described above, in the first embodiment, as a brightness distribution of the projection region of the projector 100, the brightness distribution calculating unit 109 calculates brightness of the overlapping region in which an image projected by the own projection apparatus and an image projected by the other projection apparatus overlap each other and calculates brightness of the non-overlapping region that is a region other than the overlapping region.

The offset amount determining unit 110 calculates a correction amount for correcting image data in order to make brightness (brightness when projecting a black image, i.e., an amount of black floating) uniform between the non-overlapping region and the overlapping region based on the brightness distribution of the projection region obtained by the brightness distribution calculating unit 109. A calculation method will be described later.

The offset amount determining unit 110 outputs the calculated correction amount to the correcting unit 111.

The correcting unit 111 sets an offset to the non-overlapping region of image data based on the correction amount calculated by the offset amount determining unit 110, and outputs offset-added image data to the liquid crystal panel 112.

The liquid crystal panel 112 is a light valve which modulates light from the light source 107 based on the image data corrected by the correcting unit 111. Although light modulation by the liquid crystal panel 112 involves adjusting transmittance, a method by which the light valve modulates light is not limited to adjusting transmittance.

The projection optical system 113 projects light modulated by the liquid crystal panel 112 onto a screen. The projection optical system 113 is constituted by general optical elements for projection such as a prism and a lens. A detailed description will be omitted here.

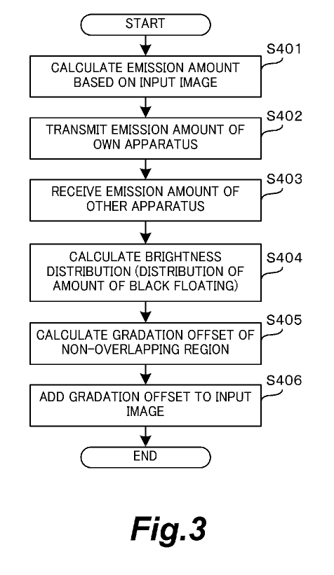

A processing flow of black correction by the projector 100 according to the first embodiment will now be described with reference to FIG. 3.

First, based on an average brightness gradation value that is statistics of image data acquired by the statistics acquiring unit 104, the emission amount determining unit 105 calculates an emission amount of the light source 107 using a lookup table (S401).

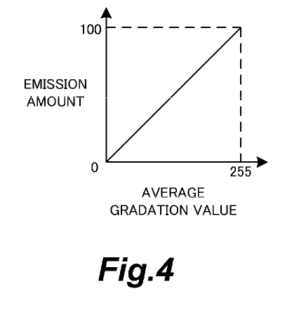

The lookup table used in the first embodiment is shown in FIG. 4. FIG. 4 shows an average gradation value of image data on a horizontal axis and an emission amount of the light source 107 on a vertical axis. When the emission amount is 0, the light source is not lighted. When the emission amount is 100, the light source is lighted at maximum brightness. In the lookup table shown in FIG. 4, the emission amount and the average gradation value have a proportional relationship so that, when the average gradation value is at a maximum value of 255, the emission amount also has a maximum value of 100. For example, when the average gradation value of the image data is 127, a calculated emission amount is 50. A relationship between the average gradation value of image data and the emission amount of a light source is not limited to this lookup table.

Next, the emission amount transmitting/receiving unit 108 transmits the emission amount of the light source 107 of the projector 100 calculated by the emission amount determining unit 105 to the projector 200 (S402).

The emission amount transmitting/receiving unit 108 receives an emission amount of the light source of the projector 200 calculated in a similar manner by the projector 200 (S403).

The brightness distribution calculating unit 109 calculates a brightness distribution (a distribution of an amount of black floating) in the projection region of the projector 100 based on the emission amounts of the projectors 100 and 200 which are to perform edge blending (S404).

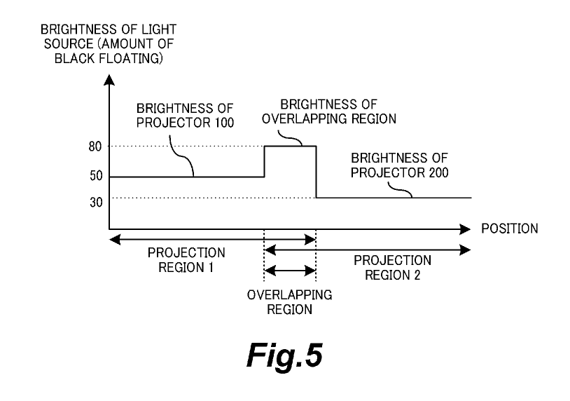

FIG. 5 shows an example of a brightness distribution of the projectors 100 and 200 which are to perform edge blending. A vertical axis represents brightness and a horizontal axis represents a position in a projection region. While FIG. 5 shows a brightness distribution of an entire projection region by the projection system constituted by the projectors 100 and 200, the brightness distribution calculated by the brightness distribution calculating unit 109 is that of a projection region 1 by the projector 100.

For example, assuming that the emission amount of the light source of the projector 100 is 50 and the emission amount of the light source of the projector 200 is 30, a value of brightness of the overlapping region is calculated by adding values of the emission amounts of the light sources of both projectors as 50+30=80. A value of brightness of the non-overlapping region is 50 which is the value of the emission amount of the projector 100.

Moreover, while the brightness of the overlapping region is determined by an addition process of the emission amounts of the projectors 100 and 200 in the first embodiment, the brightness of the overlapping region may be determined using another calculation formula such as multiplying a correction coefficient or using a lookup table in addition to the addition process.

Next, the offset amount determining unit 110 calculates an offset as a correction amount for correcting image data of the non-overlapping region in order to make an amount of black floating uniform between the overlapping region and the non-overlapping region based on the brightness distribution calculated by the brightness distribution calculating unit 109 (S405).

The offset amount determining unit 110 calculates an offset to be applied to the image data of the non-overlapping region based on a difference between the brightness of the non-overlapping region and the brightness of the overlapping region calculated by the brightness distribution calculating unit 109.

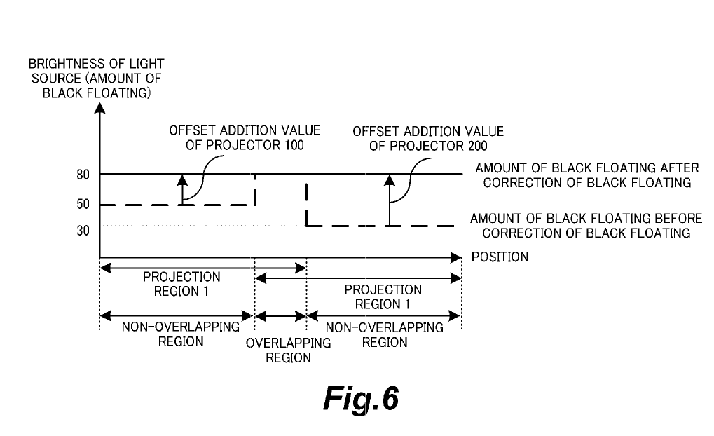

FIG. 6 shows an example of correction of black floating with respect to the brightness distribution shown in FIG. 5.

A dotted line indicates an amount of black floating prior to the correction of black floating (since correction is not performed, the amount of black floating is equal to an emission amount), and a solid line indicates an amount of black floating after the correction of black floating. With respect to the projector 100, emission amounts of the overlapping region and the non-overlapping region are respectively 80 and 50, and an offset to be added to the non-overlapping region in order to make the amount of black floating uniformly 80 is calculated as 30.

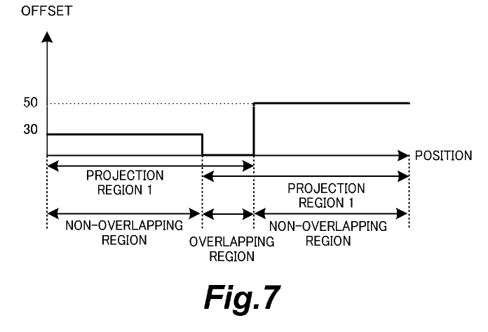

FIG. 7 shows an offset calculated based on the brightness distribution shown in FIG. 5. A vertical axis represents an offset and a horizontal axis represents a position.

The offset amount determining unit 110 outputs information of an offset in accordance with a position in the projection region 1 such as that shown in FIG. 7 to the correcting unit 111.

Next, the correcting unit 111 corrects image data by adding the offset value calculated by the offset amount determining unit 110 to the image data (S406). In the first embodiment, the correcting unit 111 performs a process of setting an offset to image data corresponding to the non-overlapping region.

In addition, at the projector 200, correction for making an amount of black floating of an overlapping region and an amount of black floating of a non-overlapping region uniform is performed by a process similar to that of the projector 100. Accordingly, a large-screen display by a multi-projection system in which a difference in black floating is reduced in a vicinity of a boundary of edge blending can be performed.

As shown in FIG. 6, in the first embodiment, a target value of correction of black floating is set based on maximum brightness in the brightness distribution of a projection region of the own projection apparatus, and a correction amount for image correction is determined. However, a method of correction is not limited thereto and correction need only be performed so that brightness (an amount of black floating) of the overlapping region and brightness (an amount of black floating) of the non-overlapping region become uniform.

As described above, in the first embodiment, an emission amount of a light source determined based on image data projected by each projector is shared by projectors through transmission and reception. A distribution of an amount of black floating in a projection region of the base projector is calculated based on the emission amount of the light source of the base projector and the emission amount of the light source of the other projector. Correction involving adding an offset to image data is performed based on a difference in amounts of black floating between an overlapping region and a non-overlapping region. Accordingly, an amount of black floating of an entire projection region can be made uniform in a multi-projection system including an edge blending process of a projector using a solid-state light source of which an emission amount can be controlled.

### Second Embodiment

The first embodiment represents a method of making an amount of black floating uniform in a case where multi-projection is performed by two projectors, in which an amount of black floating of an entire projection region of a system can be made uniform by only considering brightness distributions of projection regions of adjacent projectors.

In a second embodiment, a method of making an amount of black floating uniform when a plurality of overlapping regions are created in a system which performs multi-projection using three or more projectors will be described.

Moreover, in the following description, same portions as the first embodiment will not be described in detail and differences from the first embodiment will be described.

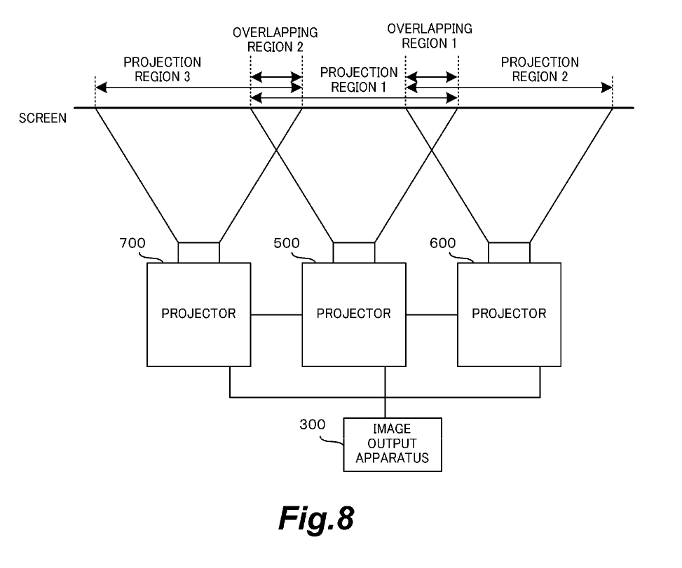

FIG. 8 is a diagram showing an outline of an arrangement of projectors in a multi-projection system according to the second embodiment. The multi-projection system according to the second embodiment of the present invention is constituted by three projectors 500, 600, and 700 in a lateral direction as shown in FIG. 7.

An image output apparatus 300 is connected to the projectors 500, 600, and 700 by an image cable and transmits image data to each projector. In addition, the projectors 500, 600, and 700 are respectively connected by a LAN cable and communicate information via the LAN cable.

The projectors 500, 600, and 700 receive image data transmitted from the image output apparatus 300 and respectively project an image based on the image data. By overlapping and splicing together parts (portions in a vicinity of a boundary) of three images projected by the three projectors 500, 600, and 700 on a projection surface, a single large-screen image is projected to and displayed on the projection surface.

Projection regions 1, 2, and 3 are, respectively, projection regions of images projected by the projectors 500, 600, and 700. An overlapping region 1 is a region where the projection regions 1 and 2 overlap each other, and an overlapping region 2 is a region where the projection regions 1 and 3 overlap each other.

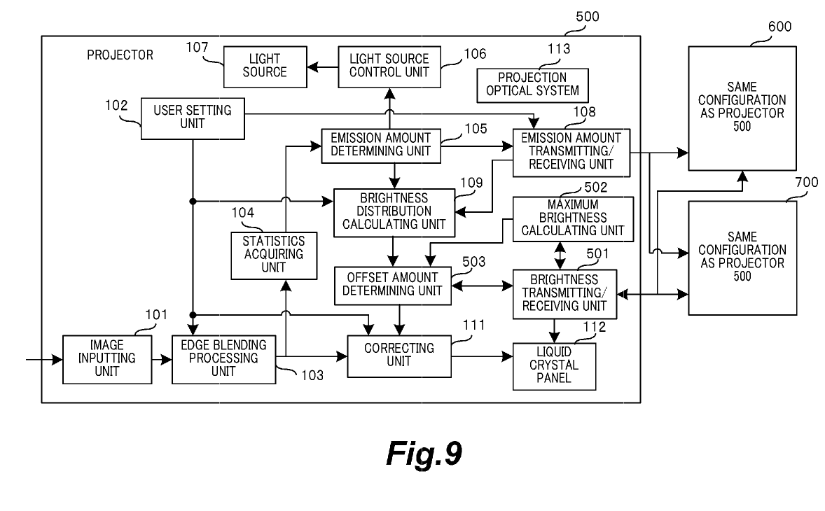

FIG. 9 is a block diagram showing a schematic configuration of the projector 500 according to the second embodiment.

Descriptions of blocks that are similar to those of the first embodiment in the configuration of the projector 500 will be omitted.

In the second embodiment, an emission amount transmitting/receiving unit 108 constitutes first acquiring unit which acquires information on an emission amount of a light source of an adjacent projection apparatus which projects an image of which a part overlaps with an image projected by the own projection apparatus among other projection apparatuses constituting the projection system. In this case, the adjacent projection apparatuses of the projector 500 are the projectors 600 and 700. Therefore, the emission amount transmitting/receiving unit 108 acquires information on emission amounts of light sources of the projectors 600 and 700.

A brightness distribution calculating unit 109 constitutes first calculating unit which calculates a characteristic amount related to brightness in the projection region of the projector 500 based on the emission amount of the light source 107 of the projector 500 and on the emission amounts of the light sources of the projectors 600 and 700 that are adjacent projection apparatuses of the projector 500.

In the second embodiment, the brightness distribution calculating unit 109 calculates a brightness distribution in the projection region of the projector 500, and obtains a maximum value of brightness in the brightness distribution (a maximum amount of black floating: hereinafter, referred to as a maximum local amount of black floating) as a characteristic amount related to brightness in the projection region of the own projection apparatus. In particular, in the second embodiment, a maximum value of brightness in a brightness distribution is a maximum value of brightness of an overlapping region in the projection region of the projector 500. In the case of the projector 500, since there are two overlapping regions 1 and 2 in the projection region 1, the brightness distribution calculating unit 109 adopts whichever is larger of brightnesses of these overlapping regions as the characteristic amount related to the brightness in the projection region of the own projection apparatus. In the case of the projectors 600 and 700, since there is only one overlapping region in the projection regions 2 and 3, the characteristic amount related to brightness in the projection region is brightness of the overlapping region.

A brightness transmitting/receiving unit 501 transmits information on the maximum local amount of black floating of the projector 500 to the projectors 600 and 700. In addition, the brightness transmitting/receiving unit 501 constitutes second acquiring unit which receives information on a characteristic amount (a maximum local amount of black floating) related to brightness in a projection region of each projector calculated in a similar manner from the projectors 600 and 700. The brightness transmitting/receiving unit 501 outputs the received information to a maximum brightness calculating unit 502.

The brightness transmitting/receiving unit 501 transmits information on a characteristic amount (to be described later) related to brightness in an entire projection region of the projection system determined by the maximum brightness calculating unit 502 to the other projectors (the projectors 600 and 700) constituting the projection system.

The maximum brightness calculating unit 502 calculates a characteristic amount related to brightness in the entire projection region of the projection system. In the second embodiment, a characteristic amount related to brightness in the entire projection region of the projection system is a maximum value of brightness in the brightness distribution (a maximum amount of black floating: hereinafter, referred to as a maximum global amount of black floating) of the entire projection region of the projection system. In particular, in the second embodiment, a maximum value of brightness in a brightness distribution of the entire projection region is a maximum value of brightness of an overlapping region in the entire projection region. In the case of the second embodiment, since there are two overlapping regions 1 and 2 in the entire projection region by the projection system, the maximum brightness calculating unit 502 adopts whichever is larger of brightnesses of the overlapping regions 1 and 2 as a characteristic amount related to the brightness in the entire projection region of the projection system. When a projection system is constituted by two projectors as in the first embodiment, since an entire projection region by the projection system has only one overlapping region, the maximum brightness calculating unit 502 adopts brightness of the overlapping region as the characteristic amount related to the brightness in the entire projection region of the projection system.

In the second embodiment, the maximum brightness calculating unit 502 determines a maximum value among maximum local amounts of black floating of the projectors 500, 600, and 700 acquired from the brightness transmitting/receiving unit 501 as the maximum global amount of black floating. The maximum brightness calculating unit 502 outputs the calculated maximum global amount of black floating to the brightness transmitting/receiving unit 501 and an offset amount determining unit 503.

The offset amount determining unit 503 determines a correction amount for correcting image data based on the maximum global amount of black floating acquired from the maximum brightness calculating unit 502, the brightness distribution acquired from the brightness distribution calculating unit 109, and a position and a size of an edge blending region acquired from the user setting unit 102. In the second embodiment, the offset amount determining unit 503 determines an offset so that, in the entire projection region by the system, brightness of an overlapping region of a projection image of each projector and a projection image of an adjacent projector and brightness of a non-overlapping region become uniform. The offset amount determining unit 503 outputs information on the offset to be set to the image data to the correcting unit 111.

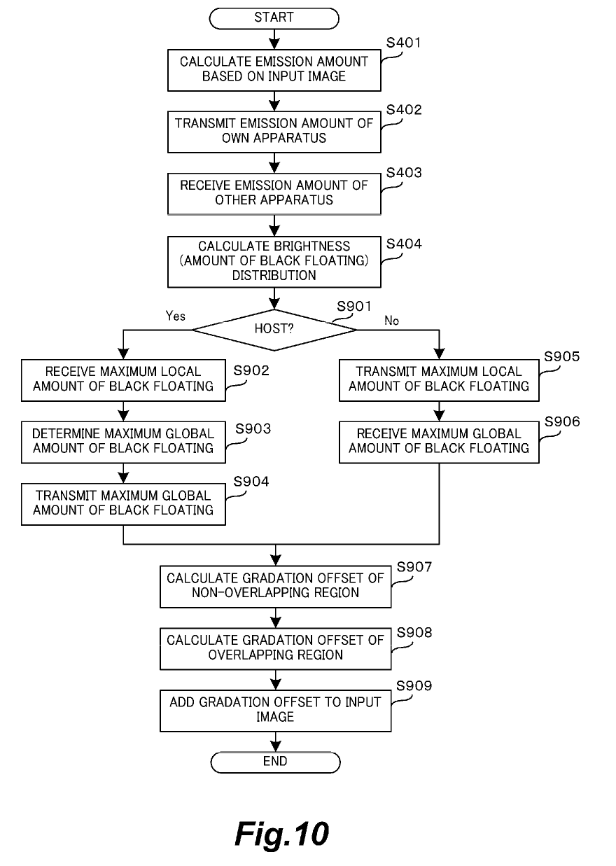

Processing of the second embodiment will now be described with reference to the flow chart shown in FIG. 10.

Processes of S401 to S404 are similar to those of the first embodiment. The emission amount determining unit 105 determines an emission amount of the light source 107 based on image data input to the projector 500, and the emission amount transmitting/receiving unit 108 transmits the emission amount to the other projectors 600 and 700 constituting the projection system. In addition, the emission amount transmitting/receiving unit 108 receives information on an emission amount of a light source of each projector having been determined by the other projectors 600 and 700. The brightness distribution calculating unit 109 calculates a brightness distribution in the projection region of the projector 500 based on information on the emission amount of the light source 107 of the base projector and information on the emission amounts of light sources of the adjacent projectors 600 and 700. In a similar manner to the first embodiment, the brightness distribution calculating unit 109 calculates brightness of the non-overlapping region based on the emission amount of the light source 107 of the base projector, and calculates brightness of the overlapping regions 1 and 2 based on the emission amount of the light source 107 of the base projector and the emission amounts of the light sources of the projectors 600 and 700 that are adjacent to the base projector.

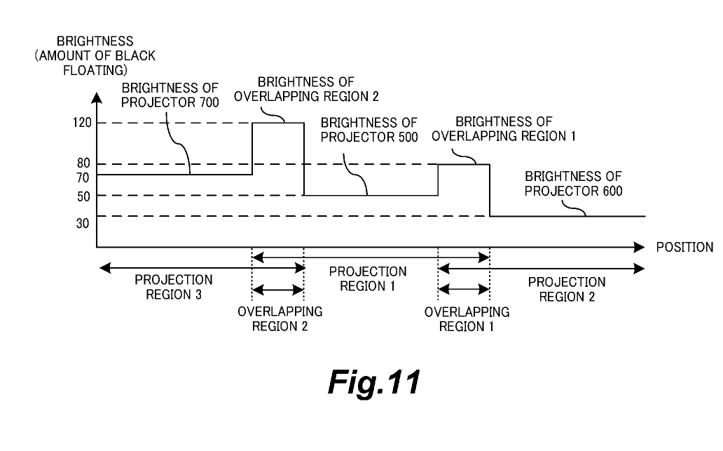

FIG. 11 shows an example of a brightness distribution in an entire projection region according to the second embodiment. A vertical axis represents brightness and a horizontal axis represents a position.

It is assumed that emission amounts of the projectors 500, 600, and 700 are, respectively, 50, 30, and 80. In this case, brightnesses of the overlapping regions 1 and 2 are, respectively, 80 and 120.

Next, the brightness transmitting/receiving unit 501 determines whether or not the projector 500 is a host device in the multi-projection system (S901).

In this case, a host device refers to a projector which receives information on a maximum local amount of black floating from each projector constituting the multi-projection system, determines a maximum global amount of black floating, and transmits information on the maximum global amount of black floating to each projector. A setting of which of the projectors constituting the projection system is to be the host device can be instructed by the user with the user setting unit 102.

However, instead of having the user set the host device, the host device may be automatically set to an arbitrary projector in the projectors constituting the projection system.

When the projector 500 is the host device (Yes in S901), the brightness transmitting/receiving unit 501 receives information on an maximum local amount of black floating from the other projectors 600 and 700 which constitute the multi-projection system (S902).

In the example shown in FIG. 11, the maximum local amount of black floating of the projector 600 is 80 of the overlapping region 1 and the maximum local amount of black floating of the projector 700 is 120 of the overlapping region 2.

The maximum brightness calculating unit 502 determines a maximum value among the received maximum local amounts of black floating of the projectors 600 and 700 and the maximum local amount of black floating of the projector 500 as a maximum global amount of black floating (S903). In the example shown in FIG. 11, the maximum brightness calculating unit 502 determines the brightness 120 of the overlapping region 2 which is the maximum local amount of black floating of the projectors 500 and 700 as the maximum global amount of black floating.

The maximum brightness calculating unit 502 transmits the determined maximum global amount of black floating to the projectors 600 and 700 (S904).

When the projector 500 is not the host device (No in S901), the brightness transmitting/receiving unit 501 transmits information on the maximum local amount of black floating of the projector 500 calculated by the brightness distribution calculating unit 109 to a prescribed projector (the host device or the first projection apparatus) (S905). In the example shown in FIG. 11, the brightness transmitting/receiving unit 501 transmits the brightness 120 of the overlapping region 2 which is the maximum local amount of black floating of the projector 500 to the projector that is the host device.

The brightness transmitting/receiving unit 501 is second acquiring unit which receives information on a maximum global amount of black floating from the host device (S906).

According to the processes described above, information on the maximum global amount of black floating is to be shared by all projectors constituting the multi-projection system.

Moreover, while an example has been described above in which a projector (a slave device or the second projection apparatus) that is not the host device transmits information on a maximum local amount of black floating to a prescribed projector (the host device), the information may be transmitted to all projectors. In this case, the slave device need not have information describing which projector is the host device.

Next, the offset amount determining unit 503 calculates an offset value of a non-overlapping region based on the maximum global amount of black floating and the brightness distribution (S907). In the second embodiment, the offset amount determining unit 503 calculates an offset for correcting image data corresponding to the non-overlapping region based on a difference between brightness of the non-overlapping region and the maximum global amount of black floating in the entire projection region of the projection system. In addition, the offset amount determining unit 503 corrects image data corresponding to an overlapping region based on a difference between brightness of the overlapping region and the maximum global amount of black floating in the entire projection region of the projection system.

In the example shown in FIG. 11, since the maximum global amount of black floating is 120 and an amount of black floating of the non-overlapping region of the projector 500 is 50, the offset amount determining unit 503 determines a difference thereof, 70, as the offset to be set to the non-overlapping region of the image data.

Next, the offset amount determining unit 503 calculates an offset value of the overlapping region based on the maximum global amount of black floating, the brightness distribution, and the number of projectors which project to the overlapping region (S908).

Since projection images by a plurality of projectors are overlapped with one another in the overlapping region, a value obtained by dividing a difference from the maximum global amount of black floating by the number of projectors which project images onto the overlapping region is adopted as the offset value of the overlapping region. Accordingly, excessive brightness due to addition of an offset corresponding to the number of projector to the overlapping region by correction can be suppressed.

In the example shown in FIG. 11, the maximum global amount of black floating is 120, amounts of black floating of the overlapping regions 1 and 2 of the projector 500 are, respectively, 80 and 120, and differences are, respectively, 40 and 0. Since the numbers of projectors that project to the overlapping regions 1 and 2 are respectively 2, the offsets are respectively calculated as 40/2=20 and 0/2=0.

Moreover, while a value obtained by dividing a difference between the maximum global amount of black floating and the brightness of an overlapping region by the number of projecting projectors is used as an offset of the overlapping region in the second embodiment, a calculation formula using a correction coefficient may be used in addition to the division.

The correcting unit 111 corrects image data based on the offset calculated by the offset amount determining unit 503 (S909).

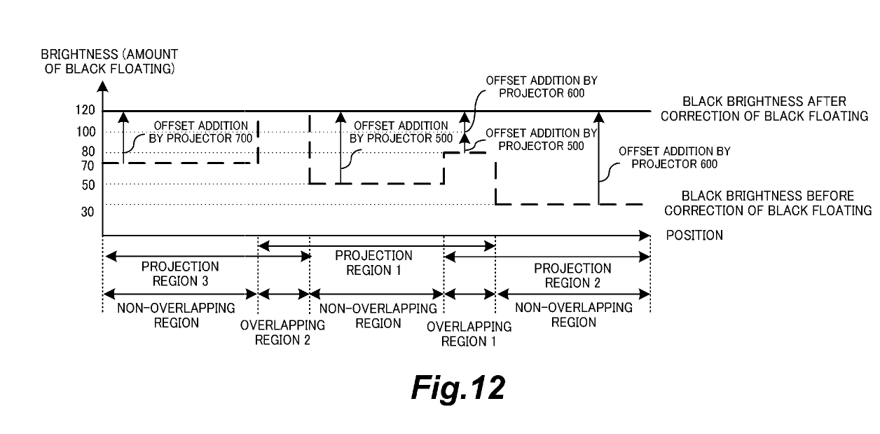

FIG. 12 shows correction for making amounts of black floating of an overlapping region and a non-overlapping region uniform in an entire multi-projection system. A vertical axis represents brightness (an amount of black floating) and a horizontal axis represents a position. In addition, a dotted line indicates brightness (an amount of black floating) before correction and a solid line indicates brightness (an amount of black floating) after the correction.

In the overlapping region 1, a uniform amount of black floating in an entire projection region by the system is realized by adding an offset with respect to each of the projectors 500 and 600 which project an image to the overlapping region 1.

In the second embodiment, a maximum value of an amount of black floating is shared by all projectors in a multi-projection system constituted by three or more projectors, and an offset addition including an overlapping region is performed at each projector based on the maximum value of an amount of black floating. Accordingly, an amount of black floating of the overlapping region and the non-overlapping region is made uniform in an entire projection region by the projection system.

However, since processes of transmitting and receiving a maximum local amount of black floating and transmitting and receiving a maximum global amount of black floating to and from each connected projector are required after a process of transmitting and receiving an emission amount as compared to the first embodiment, a delay until display is longer than in the first embodiment.

According to operations described above, a difference in amounts of black floating of an entire image can be suppressed in edge blending of a projector using three or more solid-state light sources of which an emission amount can be controlled.

### Third Embodiment

A third embodiment represents an example with a different configuration from the second embodiment with respect to correction of an amount of black floating in a multi-projection system constituted by three or more projectors.

The multi-projection system according to the third embodiment is constituted by three projectors in a similar manner to the second embodiment and, as shown in FIG. 8, a projector 500 is arranged at center, a projector 600 is arranged to the left, and a projector 700 is arranged to the right. In a similar manner to the second embodiment, the respective projectors are connected to each other by LAN cables and connected to an image output apparatus 300 by an image cable.

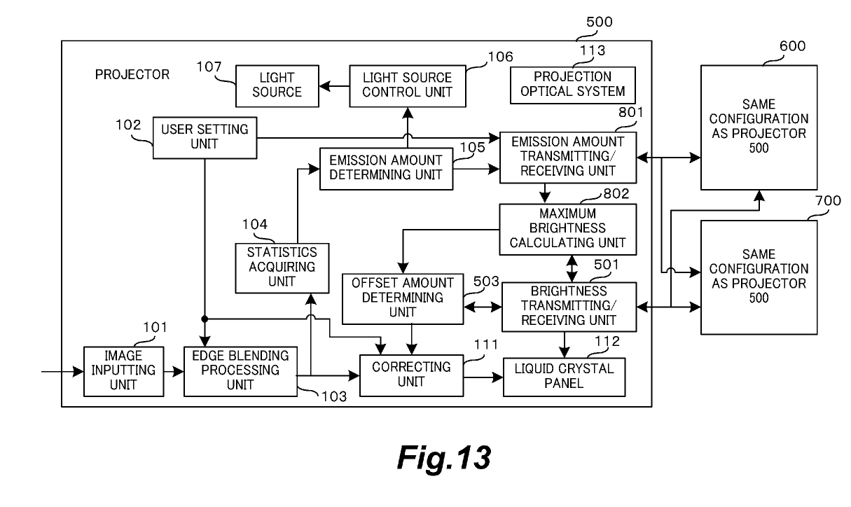

FIG. 13 is a block diagram showing a schematic configuration of the projector 500 according to the third embodiment.

A description of blocks that are similar to those of the first and second embodiments in the configuration of the projector 500 will be omitted.

When the projector 500 is a host device, an emission amount transmitting/receiving unit 801 receives information on an emission amount of a light source of each projector as determined at each projector from all projectors constituting the multi-projection system, and outputs the received information to a maximum brightness calculating unit 802.

When the projector 500 is not the host device, the emission amount transmitting/receiving unit 801 transmits information on an emission amount of a light source 107 as determined by the emission amount determining unit 105 to the host device.

In this case, a host device refers to a projector which receives information on an emission amount of a light source from each projector constituting the multi-projection system, calculates a maximum global amount of black floating based on the received information, and transmits the maximum global amount of black floating to other projectors (slave devices).

A setting of the host device is set by a user with a user setting unit 102. Alternatively, a configuration may be adopted in which an arbitrary projector is automatically set as the host device.

The maximum brightness calculating unit 802 is second calculating unit which, when the projector 500 is the host device, calculates a characteristic amount related to brightness of an entire projection region based on information on the emission amounts of the light sources of all projectors constituting the projection system, information on an arrangement of each projector, and information on a presence or absence of overlapping of each projector. The information on the emission amounts of the light sources of all projectors constituting the projection system includes the information on the emission amount of the light source of the base projector (the projector 500) determined by the emission amount determining unit 105. The information on the emission amounts of the light sources of all projectors constituting the projection system also includes information on the emission amounts of the light sources of the other projectors (the projectors 600 and 700) having been received by the emission amount transmitting/receiving unit 801. In the third embodiment, a characteristic amount related to brightness in the entire projection region of the projection system is a maximum global amount of black floating.

When the projector 500 is the host device, the brightness transmitting/receiving unit 501 transmits information on the characteristic amount related to brightness in the entire projection region of the projection system as calculated by the maximum brightness calculating unit 802 to the other projectors.

When the projector 500 is a slave device, the brightness transmitting/receiving unit 501 acquires information on the characteristic amount related to brightness in the entire projection region of the projection system from the host device.

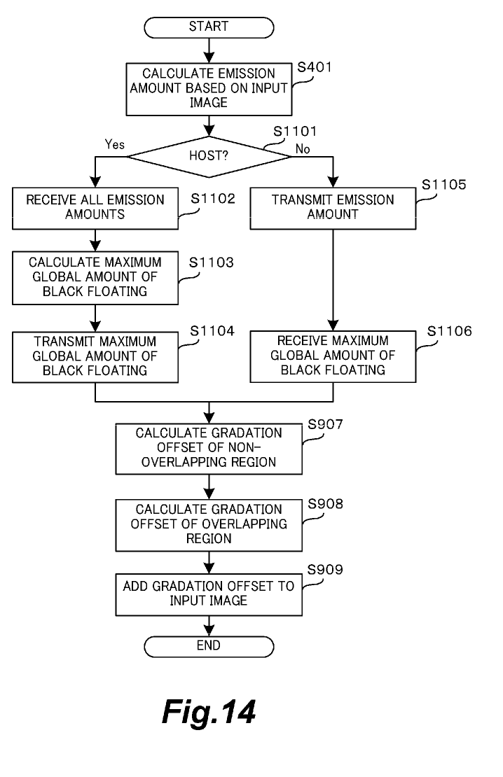

Processing of the third embodiment will now be described with reference to the flow chart shown in FIG. 14.

First, in a similar manner to the first embodiment, the emission amount determining unit 105 determines an emission amount of the light source 107 based on image data input to the projector 500 (S401).

Next, the emission amount transmitting/receiving unit 801 determines whether or not the projector 500 is a host device in the multi-projection system (S1101).

A setting of the host device is set by the user with the user setting unit 102.

However, a configuration may be adopted in which the host device is automatically set to an arbitrary projector among the connecting projectors instead of having the user set the host device.

When the projector 500 is the host device (Yes in S1101), the emission amount transmitting/receiving unit 801 receives information on an emission amount of a light source of each projector as determined by the other projectors 600 and 700 constituting the system (S1102).

In addition, the maximum brightness calculating unit 802 calculates a maximum global amount of black floating (S1103).

The maximum brightness calculating unit 802 calculates brightness of each overlapping region (an overlapping region 1 and an overlapping region 2) based on the received information on the emission amount of each projector and on information on an arrangement of each projector and information on a presence or absence of overlapping of each projector as set by the user with the user setting unit 102. While the maximum brightness calculating unit 802 calculates brightness of an overlapping region as a brightness distribution in the entire projection region by the projection system, a calculated brightness distribution is not limited thereto.

The maximum brightness calculating unit 802 determines a maximum value of the calculated brightness of the respective overlapping regions as the maximum global amount of black floating.

The brightness transmitting/receiving unit 501 transmits information on the maximum global amount of black floating calculated by the maximum brightness calculating unit 802 to the other projectors (slave devices) (S1104).

In addition, when the projector 500 is not the host device (No in S1101), the emission amount determining unit 105 transmits information on a calculated emission amount of a light source to the host device (S1105).

The brightness transmitting/receiving unit 501 receives information on a maximum global amount of black floating from the host device (S1106).

According to the above, the maximum global amount of black floating is shared by all projectors constituting the multi-projection system.

A method of calculating an offset for correcting image data based on information on the maximum global amount of black floating so that brightness of an overlapping region and brightness of a non-overlapping region in the entire projection region becomes uniform is similar to the method described in the second embodiment with reference to FIG. 10 (S907 to S909).

In the third embodiment, a maximum value of an amount of black floating is shared by all projectors in a multi-projection system constituted by three or more projectors, and an offset addition including an overlapping region is performed at each projector based on the maximum value of an amount of black floating. Accordingly, an amount of black floating of the overlapping region and the non-overlapping region is made uniform in an entire projection region by the projection system.

While a calculation process of a maximum local amount of black floating is performed at each slave device in the second embodiment, since a calculation process of a maximum local amount of black floating need not be performed by slave devices in the third embodiment, the delay until display is reduced. Moreover, in the third embodiment, the host device must possess information related to an arrangement and a presence or absence of overlapping of all projectors constituting the multi-projection system.

According to operations described above, a variation in amounts of black floating of an entire image can be suppressed in edge blending of a projector using three or more solid-state light sources of which an emission amount can be controlled.

The respective embodiments described above can be implemented in a mode in which a function of each functional block is realized by having a computer, a processor, or a CPU execute a program stored, recorded, or saved in a storage device or a memory. It is to be understood that the scope of the present invention includes a configuration which includes a processor and a memory, the memory storing a program realizing functions of the respective functional blocks described in the embodiments present above when executed by a computer.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-236925, filed on Dec. 3, 2015, which is hereby incorporated by reference herein in its entirety.

What is claimed is:

1. A projection apparatus constituting a projection system displaying a single image on a projection surface by overlapping and splicing together parts of a plurality of images projected by a plurality of projection apparatuses on the projection surface, the projection apparatus comprising:
a light source;
a light valve that modulates light from the light source based on image data;
a projecting unit configured to project the light modulated by the light valve;
a determining unit configured to determine an emission amount of the light source based on the image data;
an acquiring unit configured to acquire information on an emission amount of a light source of another projection apparatus constituting the projection system; and
a correcting unit configured to correct the image data based on the emission amount of the light source of the own projection apparatus and the emission amount of the light source of the other projection apparatus.

2. The projection apparatus according to claim 1, wherein the correcting unit corrects the image data so that, in a projection region of the own projection apparatus, brightness of an overlapping region in which an image projected by the own projection apparatus and an image projected by the other projection apparatus overlap with each other and brightness of a non-overlapping region, which is a region other than the overlapping region, become uniform.

3. The projection apparatus according to claim 2, wherein the correcting unit corrects the image data so that the brightness of the overlapping region and the brightness of the non-overlapping region become uniform when a black image is projected.

4. The projection apparatus according to claim 1, wherein the correcting unit calculates a brightness distribution in a projection region of the own projection apparatus based on the emission amount of the light source of the own projection apparatus and the emission amount of the light source of the other projection apparatus, and corrects the image data based on the brightness distribution.

5. The projection apparatus according to claim 4, wherein the correcting unit corrects the image data based on maximum brightness in the brightness distribution.

6. The projection apparatus according to claim 4, wherein the correcting unit calculates, as the brightness distribution, brightness of an overlapping region in which an image projected by the own projection apparatus and an image projected by the other projection apparatus overlap with each other and brightness of a non-overlapping region, which is a region other than the overlapping region.

7. The projection apparatus according to claim 6, wherein the correcting unit calculates the brightness of the non-overlapping region based on the emission amount of the light source of the own projection apparatus, and calculates the brightness of the overlapping region based on the emission amount of the light source of the own projection apparatus and the emission amount of the light source of the other projection apparatus.

8. The projection apparatus according to claim 6, wherein the correcting unit corrects the image data based on a difference between the brightness of the overlapping region and the brightness of the non-overlapping region.

9. The projection apparatus according to claim 8, wherein the correcting unit performs, as correction of the image data, a process of setting an offset based on a difference between the brightness of the overlapping region and the brightness of the non-overlapping region to image data corresponding to the non-overlapping region.

10. The projection apparatus according to claim 1, further comprising:
a calculating unit configured to calculate a characteristic amount related to brightness in an entire projection region of the projection system based on a characteristic amount related to brightness in a projection region of the own projection apparatus and a characteristic amount related to brightness in a projection region of the other projection apparatus; and
a transmitting unit configured to transmit information on the characteristic amount related to the brightness in the entire projection region as calculated by the calculating unit to the other projection apparatus.

11. A control method for a projection apparatus constituting a projection system displaying a single image on a projection surface by overlapping and splicing together parts of a plurality of images projected by a plurality of projection apparatuses on the projection surface,
the projection apparatus including:
a light source;
a light valve that modulates light from the light source, based on image data; and
a projecting unit configured to project light modulated by the light valve,
the control method comprising:
determining an emission amount of the light source based on the image data;
acquiring information on an emission amount of a light source of another projection apparatus constituting the projection system; and
correcting the image data based on the emission amount of the light source of the own projection apparatus and the emission amount of the light source of the other projection apparatus.
